(19) United States
(12) Patent Application Publication
(10) Pub. No.: US 2013/0234551 A1
(43) Pub. Date: Sep. 12, 2013

(54) HYDRODYNAMIC BEARING ASSEMBLY AND SPINDLE MOTOR INCLUDING THE SAME

(71) Applicant: Chang Jo YU, Suwon (KR)

(72) Inventor: Chang Jo YU, Suwon (KR)

(73) Assignee: SAMSUNG ELECTRO-MECHANICS CO., LTD., Suwon (JP)

(21) Appl. No.: 13/768,635

(22) Filed: Feb. 15, 2013

(30) Foreign Application Priority Data
Mar. 8, 2012 (KR) 10-2012-0023798

(51) Int. Cl. F16C 32/06; H02K 7/08

(52) U.S. Cl. CPC F16C 32/0633; H02K 7/08
USPC 310/90; 384/107; 384/112

(57) ABSTRACT

There are provided a hydrodynamic bearing assembly and a spindle motor including the same. The hydrodynamic bearing assembly includes: a sleeve supporting a shaft and forming a bearing clearance between the sleeve and the shaft, the bearing clearance filled with a lubricating fluid; a housing partially enclosing an outer peripheral surface of the sleeve; a rotor hub coupled to the upper end portion of the shaft and including an extension wall part partially facing an upper end portion of the sleeve and partially extended to be disposed outwardly of the housing; a stopper provided on a lower end portion of the shaft to be protruded outwardly in a radial direction to be caught by a lower end portion of the sleeve; and a circulation hole provided between the sleeve and the housing to allow a lower portion of the sleeve to communicate with an upper end portion of the housing.

### CROSS-REFERENCE TO RELATED APPLICATIONS

This application claims the priority of Korean Patent Application No. 10-2012-0023798 filed on Mar. 8, 2012, in the Korean Intellectual Property Office, the disclosure of which is incorporated herein by reference.

### BACKGROUND OF THE INVENTION

1. Field of the Invention

The present invention relates to a hydrodynamic bearing assembly and a spindle motor including the same.

2. Description of the Related Art

A small-sized spindle motor used in a hard disk drive (HDD) is generally provided with a hydrodynamic bearing assembly, and a bearing clearance formed between a shaft and a sleeve of the hydrodynamic bearing assembly is filled with a lubricating fluid such as oil. Fluid dynamic pressure is generated in the lubricating fluid filling the bearing clearance when the lubricating fluid is compressed, thereby rotatably supporting the shaft.

That is, dynamic pressure is generally generated in the hydrodynamic bearing assembly through spiral-shaped grooves formed in an axial direction and herringbone-shaped grooves formed in a circumferential direction, thereby promoting stability in rotational driving characteristics of the spindle motor.

Meanwhile, in accordance with the recent increase in storage capacities of hard disk drives, a technical problem in which vibrations generated during the driving of the spindle motor should be reduced has been encountered. That is, in order for the hard disk drive to be driven without errors due to vibrations generated during the driving of the spindle motor, improvements in the performance of the hydrodynamic bearing assembly included in the spindle motor have been demanded.

In addition, in order to improve the performance of the hydrodynamic bearing assembly, there is a need to increase an interval (that is, a bearing span length) between the herringbone shaped grooves to move the center of rotation upwardly, thereby promoting stability in the driving of the spindle motor.

In addition, the spindle motor has been used in portable electronic devices, such that demand for decreased power consumption has increased.

The development of a structure capable of decreasing power consumption while promoting stability in the driving of the motor as described above has been urgently demanded.

### RELATED ART DOCUMENT

(Patent Document 1) Japanese Patent Laid-Open Publication No. 2006-022031

### SUMMARY OF THE INVENTION

An aspect of the present invention provides a hydrodynamic bearing assembly capable of stably rotating a rotor by securing a bearing span length while preventing the generation of negative pressure, and capable of easily discharging air bubbles, as well as a spindle motor including the same.

According to an aspect of the present invention, there is provided a hydrodynamic bearing assembly including: a sleeve supporting a shaft so that an upper end portion of the shaft is protruded therefrom in an upward axial direction and forming a bearing clearance between the sleeve and the shaft, the bearing clearance being filled with a lubricating fluid; a housing partially enclosing an outer peripheral surface of the sleeve; a rotor hub coupled to the upper end portion of the shaft and including an extension wall part partially facing an outer surface of an upper end portion of the sleeve and partially extended to be disposed outwardly of the housing; a stopper provided on a lower end portion of the shaft to be protruded outwardly in a radial direction to be caught by a lower end portion of the sleeve; a cover member provided on a lower end portion of the housing; and a circulation hole provided between the sleeve and the housing to allow a lower portion of the sleeve to be in communication with an upper end portion of the housing.

The housing and the cover member may be provided integrally with each other.

The housing and the cover member provided integrally with each other may be formed by press molding.

The shaft and the rotor hub may be provided integrally with each other.

Upper and lower radial dynamic pressure grooves for generating fluid dynamic pressure at the time of rotational driving of the shaft may be formed in an outer surface of the shaft or an inner surface of the sleeve.

The sleeve may be provided with a communication hole allowing an area between the upper and lower radial dynamic pressure grooves in the bearing clearance between the shaft and the sleeve to be in communication with the circulation hole.

The upper end portion of the sleeve may be provided with a chamfer along an edge thereof, and a portion of the rotor hub facing the chamfer may have a shape corresponding to that of the chamfer.

A liquid-vapor interface may be formed between an inner surface of the extension wall part and an outer surface of the housing.

A first thrust dynamic pressure groove for generating thrust fluid dynamic pressure may be formed in at least one of an upper surface of the shaft or the stopper and a lower surface of the sleeve.

A second thrust dynamic pressure groove for generating thrust fluid dynamic pressure may be formed in at least one of a lower surface of the rotor hub and an upper surface of the sleeve.

The circulation hole may be formed by a circulation groove provided in an outer surface of the sleeve in an axial direction and an inner surface of the housing.

The circulation hole may be formed by a cut part obtained by cutting an outer surface of the sleeve in an axial direction and an inner surface of the housing.

The upper end portion of the sleeve may be provided with a flange protruded outwardly to be positioned on the upper end portion of the housing.

According to another aspect of the present invention, there is provided a spindle motor including: the hydrodynamic bearing assembly as described above; and a stator coupled to an outer side of the housing and including a core having a coil wound therearound, the coil generating rotational driving force.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIGS. 2A and 2B are perspective views showing a sleeve according to an embodiment of the present invention;

FIG. 3 is a schematic cross-sectional view showing a spindle motor according to another embodiment of the present invention;

FIGS. 4A and 4B are perspective views showing a sleeve according to another embodiment of the present invention;

FIG. 5 is a cross-sectional view schematically showing a spindle motor according to another embodiment of the present invention; and

FIGS. 6A and 6B are perspective views showing a sleeve according to another embodiment of the present invention.

### DETAILED DESCRIPTION OF THE EMBODIMENTS

Embodiments of the present invention will now be described in detail with reference to the accompanying drawings. However, it should be noted that the spirit of the present invention is not limited to the embodiments set forth herein and that those skilled in the art and understanding the present invention could easily accomplish retrogressive inventions or other embodiments included in the spirit of the present invention by the addition, modification, and removal of components, but those are to be construed as being included in the spirit of the present invention.

Moreover, detailed descriptions related to well-known functions or configurations will be ruled out in order not to unnecessarily obscure subject matters of the present invention.

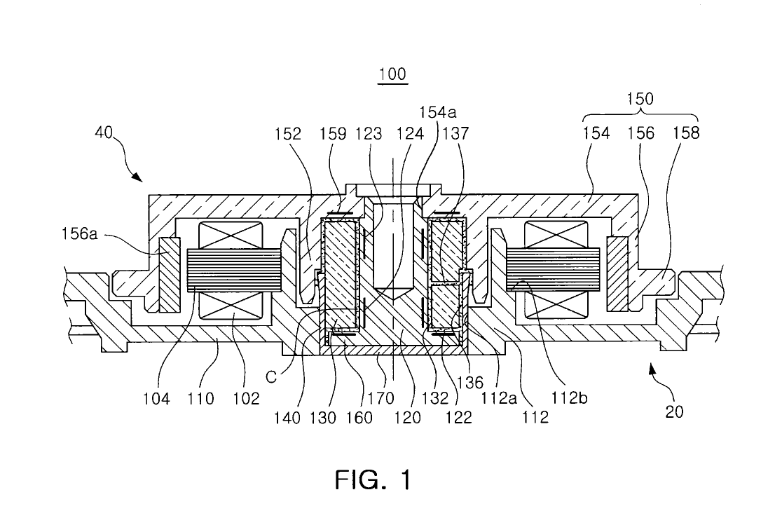

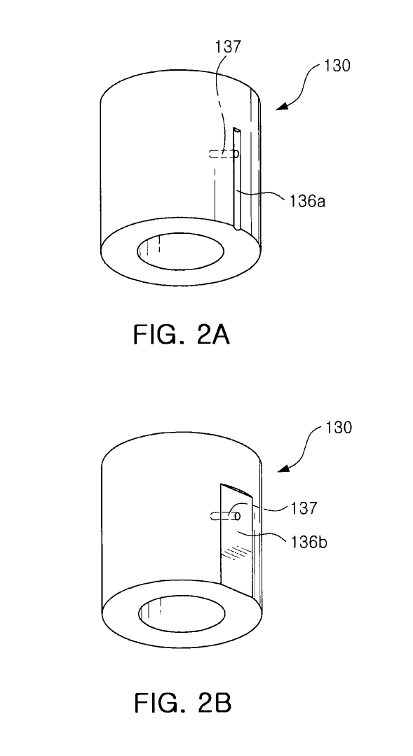

FIG. 1 is a schematic cross-sectional view showing a spindle motor according to an embodiment of the present invention; and FIGS. 2A and 2B are perspective views showing a sleeve according to the embodiment of the present invention.

Referring to FIGS. 1 through 2B, a spindle motor 100 according to the embodiment of the present invention may include a base member 110, a shaft 120, a sleeve 130, a housing 140, a rotor hub 150, a stopper 160, and a cover member 170.

The spindle motor 100 may be a motor used in a hard disk drive for driving a recoding disk.

Here, terms with respect to directions will be defined. As viewed in FIG. 1, an axial direction refers to a vertical direction, that is, a direction from a lower portion of the shaft 120 toward an upper portion thereof or a direction from the upper portion of the shaft 120 toward the lower portion thereof, while a radial direction refers to a horizontal direction, that is, a direction from an outer peripheral surface of the rotor hub 150 toward the shaft 120 or from the shaft 120 toward the outer peripheral surface of the rotor hub 150.

In addition, a circumferential direction refers to a circumference of a circle having a predetermined radius based on the shaft. For example, the circumferential direction refers to a rotation direction along the outer peripheral surface of the rotor hub 150 or the shaft 120.

Further, the hydrodynamic bearing assembly according to the embodiment of the present invention, which includes members related to a principle of a bearing utilizing fluid dynamic pressure, may include members other than the base member 110. That is, the hydrodynamic bearing assembly may include the shaft 120, the sleeve 130, the housing 140, the rotor hub 150, the stopper 160, and the cover member 170.

The base member 110, a fixed member, may configure a stator 20. Here, the stator 20, which refers to all fixed members (all members except for rotating members), may include the base member 110, the sleeve 130, the housing 140, and the like.

In addition, the base member 110 may include an installation part 112 having the housing 140 insertedly installed therein. The installation part 112 maybe protruded in an upward axial direction and include an installation hole 112a formed therein so that the housing 140 may be insertedly installed therein.

In addition, the installation part 112 may include a seat surface 112b formed on an outer peripheral surface thereof so that a stator core 104 having a coil 102 wound therearound may be seated thereon. That is, the stator core 104 may be fixedly installed on the outer peripheral surface of the installation part 112 by an adhesive in a state in which it is seated on the seat surface 112b.

However, the stator core 104 may also be installed on the outer peripheral surface of the installation part 112 in a press-fitting scheme without using the adhesive. That is, a scheme of installing the stator core 104 is not limited to the use of the adhesive.

The shaft 120, a rotating member, may configure a rotor 40. Here, the rotor 40 refers to a member rotatably supported by the stator 20 to thereby rotate.

Meanwhile, the shaft 120 may be rotatably supported by the sleeve 130. In addition, as shown in FIG. 1, the stopper 160 may include a first thrust dynamic pressure groove 122 formed in an upper surface thereof in order to generate thrust fluid dynamic pressure at the time of the rotation of the shaft 120.

Meanwhile, the first thrust dynamic pressure groove 122 is not limited to being formed in the upper surface of the stopper 160, but may also be formed on a lower surface of the sleeve 130 disposed to face the upper surface of the stopper 160.

As described above, the first thrust dynamic pressure groove 122 is formed in the upper surface of the stopper 160 or the lower surface of the sleeve 130 disposed to face the upper surface of the stopper 160, whereby the shaft 120 may smoothly rotate due to the first thrust dynamic pressure groove 122.

Meanwhile, the first thrust dynamic pressure groove 122 may have a herringbone shape or a spiral shape. However, the first thrust dynamic pressure groove 122 is not limited to having the above-mentioned shape, but may have any shape as long as the fluid dynamic pressure may be generated at the time of the rotation of the shaft 120.

Meanwhile, the shaft 120 may include upper and lower radial dynamic pressure grooves 123 and 124 formed in the outer peripheral surface thereof in order to generate fluid dynamic pressure at the time of rotational driving thereof. In addition, the upper and lower radial dynamic pressure grooves 123 and 124 may be disposed to be spaced apart from each other by a predetermined interval and have a herringbone shape.

Meanwhile, a lower end portion of the shaft 120 may be provided with the stopper 160 caught by a lower end of the sleeve 130 to limit excessive floating of the shaft 120. That is, the stopper 160 may be provided to be protruded outwardly from the lower end of the shaft 120 in the radial direction and disposed under the sleeve 130 to limit excessive floating of the rotating member including the shaft 120 at the time of an operation of the spindle motor. Therefore, the first thrust dynamic pressure groove 122 may be provided in a lower surface of the stopper 160 or in an upper surface of the cover member 170 corresponding to the lower surface of the stopper 160.

The sleeve 130, a fixed member configuring the stator 20 together with the housing 140 and the base member 110, may rotatably support the shaft 120 and form a bearing clearance C filled with a lubricating fluid. The sleeve 130 may be formed by sintering a Cu—Fe-based alloy powder or a SUS-based powder. However, the sleeve 130 is not limited to being formed by the sintering scheme, but may also be formed by other schemes.

Meanwhile, the sleeve 130 may be inserted into the installation part 112 of the base member 110 in a state in which it is fixed to the inside of the housing 140, such that it may be indirectly fixedly installed in the base member 110. That is, an outer peripheral surface of the housing 140 may be adhered to an inner peripheral surface of the installation part 112 by using an adhesive or by other schemes.

Here, only a portion of the sleeve 130 may be included in the housing 140. That is, as shown in FIG. 1, an upper end portion of the sleeve 130 is not enclosed by the housing 140, but may be exposed, to directly face an extension wall part 152 protruded from the rotor hub 150 to be described below in a downward axial direction.

Further, the sleeve 130 may include a shaft hole 132 formed therein, wherein the shaft hole 132 has the shaft 120 inserted thereinto. Further, in the case in which the shaft 120 is insertedly disposed in the shaft hole 132 of the sleeve 130, an inner peripheral surface of the sleeve 130 and the outer peripheral surface of the shaft 120 may be spaced apart from each other by a predetermined interval to form the bearing clearance C therebetween.

Here, the bearing clearance C will be described in more detail. As described above, the sleeve 130 forms the bearing clearance C filled with the lubricating fluid. This bearing clearance C indicates a clearance formed by the shaft 120 and the sleeve 130, a clearance formed by the upper end portion of the sleeve 130 and the rotor hub 150, a clearance formed by the housing 140 and the stopper 160, a clearance formed by the sleeve 130 and the extension wall part 152, and a clearance formed by the cover member 170 and a lower surface of the shaft 120.

In addition, the spindle motor 100 according to the present embodiment may have a structure in which the lubricating fluid fills the entire bearing clearance C. This structure may be called a full-fill structure.

Meanwhile, the sleeve 130 may include upper and lower radial dynamic pressure grooves formed in the inner peripheral surface thereof in order to generate fluid dynamic pressure at the time of the rotational driving of the shaft 120. In addition, the upper and lower radial dynamic pressure grooves may be disposed to be spaced apart from each other by a predetermined interval and have a herringbone or spiral shape.

Further, the sleeve 130 and the housing 140 may include a circulation hole 136 formed therebetween in order to connect upper and lower portions of the sleeve 130 to each other. The circulation hole 136 may be provided as a circulation groove 136a or a cut part 136b formed in at least one of an outer peripheral surface of the sleeve 130 and an inner peripheral surface of the housing 140.

In the case in which the circulation hole 136 is provided as the circulation groove 136a formed along the outer peripheral surface of the sleeve 130 to allow the upper and lower portions of the sleeve 130 to be in communication with each other, the circulation groove 136a may be formed by forming a groove in a side of the sleeve 130 in the vertical direction (the axial direction based on FIG. 1). Since the housing 140 does not enclose the entire outer surface of the sleeve 130, the circulation groove 136a may be formed up to a portion at which an upper end of the housing 140 is positioned.

Further, in the case in which the circulation hole 136 is provided as the cut part 136b along the outer peripheral surface of the sleeve 130 to allow the upper and lower portions of the sleeve 130 to be in communication with each other, the cut part 136b may be formed by cutting the side of the sleeve 130 in the vertical direction (the axial direction based on FIG. 1). Since the outer peripheral surface of the sleeve 130 and the inner peripheral surface of the housing 140 have a circular shape, when the outer peripheral surface of the sleeve 130 is cut in the vertical direction (in the axial direction based on FIG. 1), a space between the sleeve 130 and the housing 140 is naturally formed, such that the first circulation hole 136 may be provided. In this case, since the housing 140 does not enclose the entire outer surface of the sleeve 130, the cut part 136b may be formed up to the portion at which the upper end of the housing 140 is positioned.

Further, in the case in which the circulation hole is formed along the inner peripheral surface of the housing 140, the circulation hole may be formed by using the same scheme as the scheme of forming the circulation hole in the outer peripheral surface of the sleeve 130.

Meanwhile, the sleeve 130 may be provided with a communication hole 137 allowing the bearing clearance C between the shaft 120 and the sleeve 140 to be in communication with the circulation hole 136. Here, the communication hole 137 may allow a portion between the upper and lower radial dynamic pressure grooves 123 and 124 to be in communication with the circulation hole 136.

According to the present embodiment, the communication hole 137 is provided to prevent negative pressure from being generated between the upper and lower radial dynamic pressure grooves 123 and 124, whereby a bearing span length may be increased. That is, even though the upper radial bearing has an unbalanced herringbone shape which pumps the lubricating fluid toward a second thrust bearing formed by a second thrust dynamic pressure groove 159 and the lower radial bearing has an unbalanced herringbone shape which pumps the lubricating fluid toward a first thrust bearing formed by the first thrust dynamic pressure groove 122, since the generation of negative pressure may be prevented by the communication hole 137 provided between the upper and lower radial dynamic pressure grooves 123 and 124, the bearing span length may be increased to improve rotational characteristics of the spindle motor while reducing power consumption.

Here, the bearing span length indicates a distance between a region in which maximum dynamic pressure is generated while the lubricating fluid is pumped by the upper radial dynamic pressure groove 123 and a region in which maximum dynamic pressure is generated while the lubricating fluid is pumped by the lower radial dynamic pressure groove 124.

That is, the communication hole 137 is installed in the sleeve 130, such that a spaced distance between the upper and lower radial dynamic pressure grooves 123 and 124 is increased, whereby the bearing span length may be increased. Therefore, the rotational characteristics may be improved and the power consumption may be reduced.

The housing 140 may enclose the sleeve 130 such that it may be coupled to the outer peripheral surface of the sleeve 130. More specifically, the sleeve 130 may be inserted into the inner peripheral surface of the housing 140 and be coupled thereto by press-fitting or bonding. Since the upper end portion of the sleeve 130 is provided to be exposed, the housing 140 may be coupled to the sleeve 130 except for an outer surface of the upper end portion of the sleeve 130.

Therefore, since the housing 140 may have a short length in the axial direction, in the case in which the housing is manufactured in a pressing scheme, the housing may be easily manufactured.

The housing 140 may be coupled to the outer peripheral surface of the sleeve 130 containing oil to prevent the oil from being leaked.

In addition, an outer surface of the upper end portion of the housing 140 and the extension wall part 152 protruded from the rotor hub 150 in the downward axial direction may have an oil interface formed therebetween. That is, the bearing clearance C is filled with the oil, sealed by a capillary phenomenon. According to the present embodiment, a sealing part of the fluid may be formed between the outer surface of the housing 140 and the inner surface of the extension wall part 152. A position of the oil interface may be changed according to whether or not the spindle motor is operated.

Therefore, the outer surface of the upper end portion of the housing 140 or the inner surface of the extension wall part 152 may be tapered so that the oil is easily sealed. That is, the outer surface of the upper end portion of the housing 140 or the inner surface of the extension wall part 152 may be inclined so that an interface between the lubricating fluid and air is easily formed.

Meanwhile, the housing 140 may include the cover member 170 installed on a lower end portion thereof.

The cover member 170, a fixed member configuring the stator 20 together with the base member 110, the sleeve 130, and the housing 140 described above, may be installed on the lower end portion of the housing 140 to serve to prevent the lubricating fluid filling the bearing clearance C from being leaked to the lower end portion of the housing 140.

Here, the cover member 170 may be bonded to the lower end portion of the housing 140 by an adhesive and/or welding.

In addition, the cover member 170 may be provided integrally with the housing 140. In the case in which the housing 140 and the cover member 170 are provided integrally with each other, the housing 140 and the cover member 170 may be manufactured integrally with each other by press molding.

The rotor hub 150, a rotating member configuring the rotor 40 together with the shaft 120, may be coupled to the upper end portion of the shaft 120 and include the extension wall part 152 extended to be disposed outwardly of the sleeve 130.

Meanwhile, the rotor hub 150 may include a rotor hub body 154 provided with an mounting hole 154a into which the upper end portion of the shaft 120 is inserted, a magnet mounting part 156 extended from an edge of the rotor hub body 154 in the downward axial direction, and a disk seat part 158 extended outwardly from a distal end of the magnet mounting part 156 in the radial direction.

In addition, the magnet mounting part 156 may have a driving magnet 156a installed on an inner surface thereof, and the driving magnet 156a is disposed to face a front end of the stator core 104 having the coil 102 wound therearound.

Meanwhile, the driving magnet 156a may have an annular ring shape and be a permanent magnet generating magnetic force having a predetermined strength by alternately magnetizing an N pole and an S pole in the circumferential direction.

Here, the rotational driving of the rotor hub 150 will be briefly described. When power is supplied to the coil 102 wound around the stator core 104, driving force capable of rotating the rotor hub 150 may be generated by electromagnetic interaction between the driving magnet 156a and the stator core 104 having the coil 102 wound therearound.

Therefore, the rotor hub 150 may rotate. In addition, the shaft 120 on which the rotor hub 150 is fixedly installed may rotate together with the rotor hub 150 by the rotation thereof.

Further, the above-mentioned extension wall part 152 may be extended from a lower surface of the rotor hub body 154 in the downward axial direction.

The extension wall part 152 may partially face the outer surface of the upper end portion of the sleeve 130 and be partially disposed outwardly of the housing 140. That is, since the upper end portion of the sleeve 130 is not enclosed by the housing 140, the upper end portion of the sleeve 130 may directly face the extension wall part 152, and the bearing clearance C formed by the upper end portion of the sleeve 130 and the extension wall part 152 may be filled with the lubricating fluid.

Meanwhile, the rotor hub 150 may be provided integrally with the shaft 120.

In addition, the second thrust dynamic pressure groove 159 for generating thrust fluid dynamic pressure may be formed in at least one of the upper surface of the sleeve 130 and the lower surface of the rotor hub body 154 facing the upper surface of the sleeve 130.

Therefore, at the time of the rotation of the shaft 120, the thrust fluid dynamic pressure is generated, whereby the rotation of the rotor hub 150 may be more stably supported.

Hereinafter, a spindle motor according to another embodiment of the present invention will be described with reference to the accompanying drawings. However, a detailed description of the same components as the above-mentioned components will be omitted.

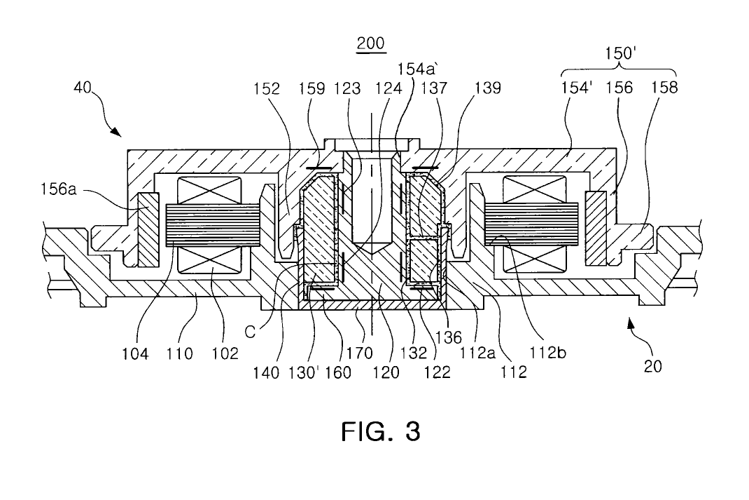

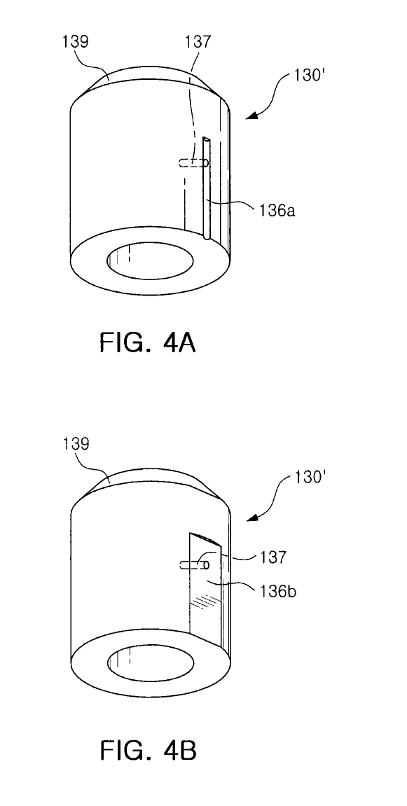

FIG. 3 is a schematic cross-sectional view showing a spindle motor according to another embodiment of the present invention; and FIGS. 4A and 4B are perspective views showing a sleeve according to another embodiment of the present invention.

Referring to FIGS. 3 through 4B, a spindle motor 200 according to another embodiment of the present invention may include abase member 110, a shaft 120, a sleeve 130′, a housing 140, a rotor hub 150′, a stopper 160, and a cover member 170. That is, the spindle motor 200 according to this embodiment of the present invention has the same components as those of the spindle motor according to the embodiment of the present invention shown in FIGS. 1 through 2B except for the sleeve 130′ and the rotor hub 150′. Therefore, a detailed description of the same components will be omitted.

According to this embodiment of the present invention, an upper end portion of the sleeve 130′ may be provided with a chamfer 139 in the circumferential direction, and a portion of the rotor hub 150′, that is, a rotor hub body 154′ facing the chamfer 139 may have a shape corresponding to that of the chamfer 139.

When the portion of the rotor hub 150′ facing the chamfer 139 has this shape, since a contact area between a rotating member (that is, the rotor hub 150′) and a fixed member (that is, the sleeve 130′) is decreased, friction is decreased, such that the spindle motor may be operated at low current.

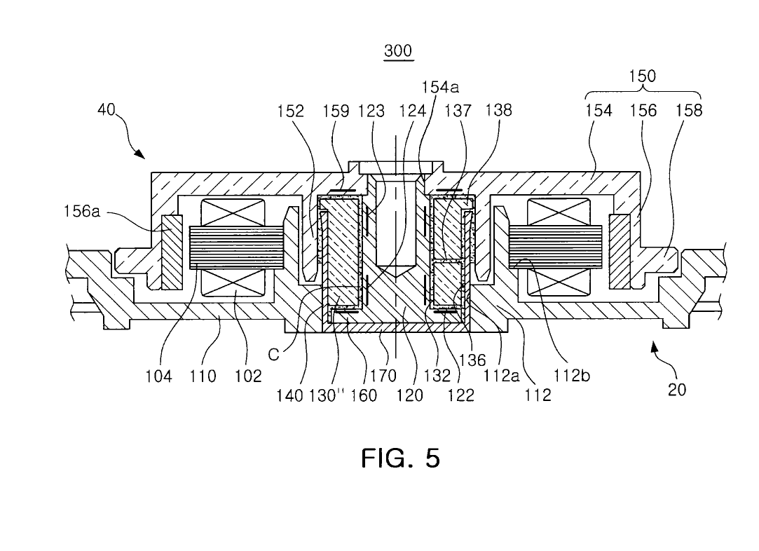

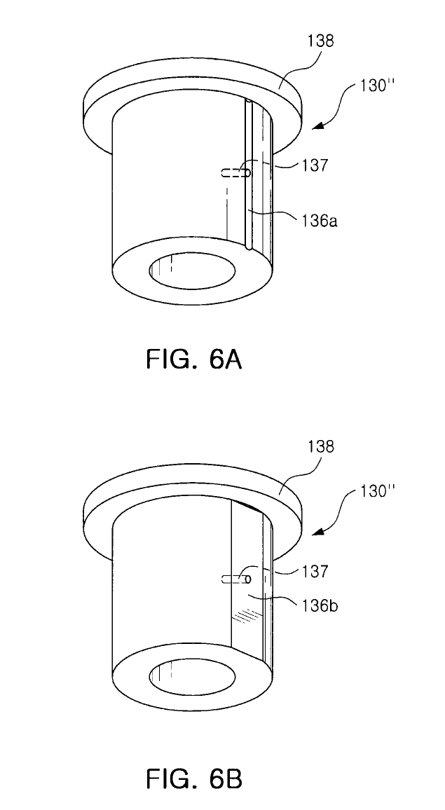

FIG. 5 is a schematic cross-sectional view showing a spindle motor according to another embodiment of the present invention; and FIGS. 6A and 6B are perspective views showing a sleeve according to another embodiment of the present invention.

Referring to FIGS. 5 through 6B, a spindle motor 300 according to another embodiment of the present invention may include abase member 110, a shaft 120, a sleeve 130″, a housing 140, a rotor hub 150, a stopper 160, and a cover member 170. That is, the spindle motor 300 according to another embodiment of the present invention has the same components as those of the spindle motor according to the embodiment of the present invention shown in FIGS. 1 through 23 except for the sleeve 130″. Therefore, a detailed description of the same components will be omitted.

According to this embodiment of the present invention, an upper end portion of the sleeve 130″ may be provided with a flange 138 in the circumferential direction. The flange 138 may be positioned on the upper end portion of the housing 140 into which the sleeve is inserted.

As set forth above, according to embodiments of the present invention, a bearing span length is secured while the generation of negative pressure is prevented, whereby a motor may be stably operated.

In addition, a hydrodynamic bearing assembly capable of being stably operated by easily discharging air bubbles and capable of decreasing power consumption due to low friction current, and a spindle motor including the same may be provided.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly comprising:
a sleeve supporting a shaft so that an upper end portion of the shaft is protruded therefrom in an upward axial direction and forming a bearing clearance between the sleeve and the shaft, the bearing clearance being filled with a lubricating fluid;
a housing partially enclosing an outer peripheral surface of the sleeve;
a rotor hub coupled to the upper end portion of the shaft and including an extension wall part partially facing an outer surface of an upper end portion of the sleeve and partially extended to be disposed outwardly of the housing;
a stopper provided on a lower end portion of the shaft to be protruded outwardly in a radial direction to be caught by a lower end portion of the sleeve;
a cover member provided on a lower end portion of the housing; and
a circulation hole provided between the sleeve and the housing to allow a lower portion of the sleeve to be in communication with an upper end portion of the housing.

2. The hydrodynamic bearing assembly of claim 1, wherein the housing and the cover member are provided integrally with each other.

3. The hydrodynamic bearing assembly of claim 2, wherein the housing and the cover member provided integrally with each other are formed by press molding.

4. The hydrodynamic bearing assembly of claim 1, wherein the shaft and the rotor hub are provided integrally with each other.

5. The hydrodynamic bearing assembly of claim 1, wherein upper and lower radial dynamic pressure grooves for generating fluid dynamic pressure at the time of rotational driving of the shaft are formed in an outer surface of the shaft or an inner surface of the sleeve.

6. The hydrodynamic bearing assembly of claim 5, wherein the sleeve is provided with a communication hole allowing a portion between the upper and lower radial dynamic pressure grooves in the bearing clearance between the shaft and the sleeve to be in communication with the circulation hole.

7. The hydrodynamic bearing assembly of claim 1, wherein the upper end portion of the sleeve is provided with a chamfer along an edge thereof, and
a portion of the rotor hub facing the chamfer has a shape corresponding to that of the chamfer.

8. The hydrodynamic bearing assembly of claim 1, wherein a liquid-vapor interface is formed between an inner surface of the extension wall part and an outer surface of the housing.

9. The hydrodynamic bearing assembly of claim 1, wherein a first thrust dynamic pressure groove for generating thrust fluid dynamic pressure is formed in at least one of an upper surface of the stopper and a lower surface of the sleeve.

10. The hydrodynamic bearing assembly of claim 1, wherein a second thrust dynamic pressure groove for generating thrust fluid dynamic pressure is formed in at least one of a lower surface of the rotor hub and an upper surface of the sleeve.

11. The hydrodynamic bearing assembly of claim 1, wherein the circulation hole is formed by a circulation groove provided in an outer surface of the sleeve in an axial direction and an inner surface of the housing.

12. The hydrodynamic bearing assembly of claim 1, wherein the circulation hole is formed by a cut part obtained by cutting an outer surface of the sleeve in an axial direction and an inner surface of the housing.

13. The hydrodynamic bearing assembly of claim 1, wherein the upper end portion of the sleeve is provided with a flange protruded outwardly to be positioned on the upper end portion of the housing.

14. A spindle motor comprising:
the hydrodynamic bearing assembly of claim 1; and
a stator coupled to an outer side of the housing and including a core having a coil wound therearound, the coil generating rotational driving force.
